(19) United States
(12) Patent Application Publication
(10) Pub. No.: US 2013/0122766 A1
(43) Pub. Date: May 16, 2013

(54) CURABLE COMPOSITIONS

(71) Applicants: Sudhakar Balijepalli, Midland, MI (US); Michael J. Mullins, Houston, TX (US); Irina Graf, Midland, MI (US); Raymond J. Thibault, Lake Jackson, TX (US); Ashwin Bharadwaj, Pearland, TX (US); Anteneh Worku, Pearland, TX (US)

(72) Inventors: Sudhakar Balijepalli, Midland, MI (US); Michael J. Mullins, Houston, TX (US); Irina Graf, Midland, MI (US); Raymond J. Thibault, Lake Jackson, TX (US); Ashwin Bharadwaj, Pearland, TX (US); Anteneh Worku, Pearland, TX (US)

(73) Assignee: DOW GLOBAL TECHNOLOGIES LLC, Midland, MI (US)

(21) Appl. No.: 13/812,208

(22) PCT Filed: Jul. 19, 2011
(86) PCT No.: PCT/US11/01281

§ 371 Date: Jan. 25, 2013

Related U.S. Application Data
(60) Provisional application No. 61/369,486, filed on Jul. 30, 2010.

(51) Int. Cl. C09D 163/04

(52) U.S. Cl. CPC C09D 163/04
USPC 442/142; 523/427; 523/428

(57) ABSTRACT

Embodiments of the present disclosure include a curable composition including an epoxy compound selected from the group consisting of aromatic epoxy compounds, alicyclic epoxy compounds, aliphatic epoxy compounds, and combinations thereof, a curing agent selected from the group consisting of novolacs, amines, anhydrides, carboxylic acids, phenols, thiols, and combinations thereof, and a phosphono-methyl-glycine.

### FIELD OF DISCLOSURE

Embodiments of the present disclosure are directed toward curable compositions; more specifically, embodiments are directed toward curable compositions including a phosphono-methyl-glycine.

### BACKGROUND

Epoxy systems may consist of two components that can chemically react with each other to form a cured epoxy, which is a hard, inert material. The first component can be an epoxy compound and the second component can be a curing agent, sometimes called a hardener. Epoxy compounds contain epoxide groups. The hardener includes compounds which are reactive to the epoxide groups of the epoxy compounds.

The epoxy compounds can be crosslinked, also referred to as curing, by the chemical reaction of the epoxide groups and the compounds of the hardener. This curing converts the epoxy compounds into crosslinked materials by chemical reaction with the hardener.

Epoxy systems can be used to make composite materials. Composite materials are materials that are made from two or more components that have distinct mechanical properties. For example, a composite material may be formed of multiple layers of a reinforcing fiber having an epoxy compound that is employed as a matrix material. Each layer that makes up the composite material can be impregnated with the epoxy compound. These layers may be referred to as prepregs. The prepregs can then be cured by application of heat and/or pressure to form the composite material. The heat and/or pressure cause the epoxy compound to penetrate and join all layers of the prepreg together as the epoxy compound cures.

For some applications, it may desirable that the composite material have flame retardation properties. Fire is a gas-phase reaction. Thus, in order for a composite material to burn, a portion of it must be in the gas-phase. Portions of composite materials can transition to the gas-phase by decomposition via exposure to heat. Ignition of the gas-phase can occur either spontaneously or result from an external source such as a spark or flame. Upon ignition of the gas-phase, if the heat evolved by the burning is sufficient to keep the decomposition rate of the composite material above that required to maintain the evolved gas-phase components within a flammability limit, then a self-sustaining combustion cycle will be established.

Generally to reduce flammability, composite materials have included either flame retardants that help provide a protective layer, e.g. a char, on the composite material that helps reduce decomposition to the gas-phase or flame retardants that evolve an inert gas upon decomposition to dilute the flammable gasses so that burning is extinguished.

The suitability of a flame retardant depends on a variety of factors that limit the number of acceptable materials that can be included in composite materials. These factors can include flammability properties and technical properties of the composite materials.

### SUMMARY

One or more embodiments of the present disclosure include a curable composition including an epoxy compound selected from the group consisting of aromatic epoxy compounds, alicyclic epoxy compounds, aliphatic epoxy compounds, and combinations thereof; a curing agent selected from the group consisting of novolacs, amines, anhydrides, carboxylic acids, phenols, thiols, and combinations thereof; and a phosphono-methyl-glycine.

One or more embodiments of the present disclosure include a prepreg obtainable by impregnating a matrix component into a reinforcement component, wherein the matrix component is the curable composition as disclosed herein.

One or more embodiments of the present disclosure include a product obtained by curing one or more of the prepregs as disclosed herein.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Embodiments of the present disclosure provide curable compositions. The curable compositions can include a phosphono-methyl-glycine, an epoxy compound, and a curing agent.

Phosphono-methyl-glycines, such as glyphosate, have been used as a broad-spectrum systemic herbicide to kill weeds. Glyphosate salts have been sold as an herbicide under the tradename ROUNDUP®. Additionally, glyphosate has been used to generate phosphorous acid functional acrylic copolymers having internal pendant phosphorus acid groups that are useful as an adhesive.

Surprisingly, it has been found that phosphono-methyl-glycines may be included in the curable compositions of the present disclosure and that products obtained by curing the curable compositions have both desirable flammability properties, such as particular flame classifications, and desirable technical properties, such as glass transition temperatures.

Phosphono-methyl-glycines may be represented by the following Formula I:

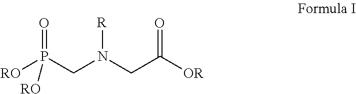

For Formula I, each R is independently a hydrogen atom, an alkyl group, an aryl group, a glycidyl group, a 2-hydroxymethyl group, a 2-hydroxyethyl group, or an R¹C═O group.

The alkyl groups, having the formula —CₙH₂ₙ₊₁, can be derived from an alkane by removal of a hydrogen atom from a carbon atom. Alkyl groups can include cycloalkyl groups that have the formula CₙH₂ₙ₋₁. Cycloalkyl groups can be derived from cycloalkanes by removal of a hydrogen atom from a ring carbon atom.

The aryl groups can be derived from arenes by removal of a hydrogen atom from a ring carbon atom. Arenes, including heteroarenes, are monocyclic or polycyclic aromatic hydrocarbons.

The glycidyl groups can include methylene oxiranes, for example, that can be derived by displacement chemistry of glycidyl halides such as epichlorohydrin.

The 2-hydroxyethyl groups can include HOCH₂CH₂— radicals, HOCH₂CH(CH₃)— radicals, HOCH(CH₃)CH₂— radicals, or combinations thereof, for example, that can be derived from epoxy ring-opening reactions of ethylene oxide or propylene oxide.

The R¹C═O groups can include acyl radicals where R¹ is hydrogen, a CₙH₂ₙ₊₁ group, a CₙH₂ₙ₋₁ group, a cycloalkane, an aryl group, or a combination thereof.

A specific phosphono-methyl-glycine, where each R is independently hydrogen, is glyphosate. Glyphosate may be represented by the following Formula II:

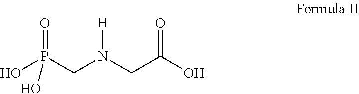

The phosphono-methyl-glycines include salts thereof, e.g. salts of Formula I. For one or more of the embodiments, the phosphono-methyl-glycine can include a salt of Formula I that is a combination of a cation with an mono- or dianionic form of Formula I. Examples of such salts include, but are not limited to, alkyl ammonium salts such as ammonium, diammonium, isopropylammonium, trimethylsulfonium, phosphonium, potassium, sodium, magnesium, aluminum, and combinations thereof. For one or more of the embodiments, the most preferred salts are the isopropylammonium and the trimethyl sulfonium salts. Additionally, the phosphono-methyl-glycines include anhydrides thereof that are obtainable by water removal, e.g. anhydrides of Formula I. The phosphono-methyl-glycine can be from 0.5 weight percent to 50 weight percent of the curable composition; for example the phosphono-methyl-glycine can be from 1 weight percent to 40 weight percent or from 2 weight percent to 30 weight percent of the curable composition.

As used herein, “a,” “an,” “the,” “at least one,” and “one or more” are used interchangeably. The term “and/or” means one, one or more, or all of the listed items. The recitations of numerical ranges by endpoints include all numbers subsumed within that range (e.g., 1 to 5 includes 1, 1.5, 2, 2.75, 3, 3.80, 4, 5, etc.).

For one or more embodiments, the curable compositions include an epoxy compound. A compound is a substance composed of atoms or ions of two or more elements in chemical combination and an epoxy compound is a compound in which an oxygen atom is directly attached to two adjacent or non-adjacent carbon atoms of a carbon chain or ring system. The epoxy compound can be from 10 weight percent to 90 weight percent of the curable composition; for example the epoxy compound can be from 20 weight percent to 80 weight percent or from 30 weight percent to 70 weight percent of the curable composition.

The epoxy compound can be selected from the group consisting of aromatic epoxy compounds, alicyclic epoxy compounds, aliphatic epoxy compounds, and combinations thereof.

For one or more embodiments, the curable compositions include an aromatic epoxy compound. Examples of aromatic epoxy compounds include, but are not limited to, glycidyl ether compounds of polyphenols, such as hydroquinone, resorcinol, bisphenol A, bisphenol F, 4,4′-dihydroxybiphenyl, phenol novolac, cresol novolac, trisphenol (tris-(4-hydroxyphenyl)methane), 1,1,2,2-tetra(4-hydroxyphenyl)ethane, tetrabromobisphenol A, 2,2-bis(4-hydroxyphenyl)-1,1,1,3,3,3-hexafluoropropane, 1,6-dihydroxynaphthalene, and combinations thereof.

For one or more embodiments, the curable composition's include an alicyclic epoxy compound. Examples of alicyclic epoxy compounds include, but are not limited to, polyglycidyl ethers of polyols having at least one alicyclic ring, or compounds including cyclohexene oxide or cyclopentene oxide obtained by epoxidizing compounds including a cyclohexene ring or cyclopentene ring with an oxidizer. Some particular examples include, but are not limited to, hydrogenated bisphenol A diglycidyl ether; 3,4-epoxycyclohexylmethyl-3,4-epoxycyclohexyl carboxylate; 3,4-epoxy-1-methylcyclohexyl-3,4-epoxy-1-methylhexane carboxylate; 6-methyl-3,4-epoxycyclohexylmethyl-6-methyl-3,4-epoxycyclohexane carboxylate; 3,4-epoxy-3-methylcyclohexylmethyl-3,4-epoxy-3-methylcyclohexane carboxylate; 3,4-epoxy-5-methylcyclohexylmethyl-3,4-epoxy-5-methylcyclohexane carboxylate; bis(3,4-epoxycyclohexylmethyl)adipate; methylene-bis(3,4-epoxycyclohexane); 2,2-bis(3,4-epoxycyclohexyl)propane; dicyclopentadiene diepoxide; ethylene-bis(3,4-epoxycyclohexane carboxylate); dioctyl epoxyhexahydrophthalate; di-2-ethylhexyl epoxyhexahydrophthalate; and combinations thereof.

For one or more embodiments, the curable compositions include an aliphatic epoxy compound. Examples of aliphatic epoxy compounds include, but are not limited to, polyglycidyl ethers of aliphatic polyols or alkylene-oxide adducts thereof, polyglycidyl esters of aliphatic long-chain polybasic acids, homopolymers synthesized by vinyl-polymerizing glycidyl acrylate or glycidyl methacrylate, and copolymers synthesized by vinyl-polymerizing glycidyl acrylate or glycidyl methacrylate and other vinyl monomers. Some particular examples include, but are not limited to glycidyl ethers of polyols, such as 1,4-butanediol diglycidyl ether; 1,6-hexanediol diglycidyl ether; a triglycidyl ether of glycerin; a triglycidyl ether of trimethylol propane; a tetraglycidyl ether of sorbitol; a hexaglycidyl ether of dipentaerythritol; a diglycidyl ether of polyethylene glycol; and a diglycidyl ether of polypropylene glycol; polyglycidyl ethers of polyether polyols obtained by adding one type, or two or more types, of alkylene oxide to aliphatic polyols such as propylene glycol, trimethylol propane, and glycerin; diglycidyl esters of aliphatic long-chain dibasic acids; and combinations thereof.

For one or more embodiments, the curable compositions include a curing agent. The curing agent can be selected from the group consisting of novolacs, amines, anhydrides, carboxylic acids, phenols, thiols, and combinations thereof. The curing agent can be from 1 weight percent to 50 weight percent of the curable composition; for example the curing agent can be from 5 weight percent to 45 weight percent or from 10 weight percent to 40 weight percent of the curable composition.

For one or more of the embodiments, the curing agent can include a novolac. Examples of novolacs include phenol novolacs. Phenols can be reacted in excess, with formaldehyde in the presence of an acidic catalyst to produce phenol novolacs.

For one or more of the embodiments, the curing agent can include an amine. Amines include compounds that contain an N—H moiety, e.g. primary amines and secondary amines. The amine can be selected from the group consisting of aliphatic polyamines, arylaliphatic polyamines, cycloaliphatic polyamines, aromatic polyamines, heterocyclic polyamines, polyalkoxy polyamines, dicyandiamide and derivatives thereof, aminoamides, amidines, ketimines, and combinations thereof.

Examples of aliphatic polyamines include, but are not limited to, ethylenediamine (EDA), diethylenetriamine (DETA), triethylenetetramine (TETA), trimethyl hexane diamine (TMDA), hexamethylenediamine (HMDA), N-(2-aminoethyl)-1,3-propanediamine (N₃-Amine), N,N′-1,2-ethanediylbis-1,3-propanediamine (N₄-amine), dipropylenetriamine, and reaction products of an excess of these amines with an epoxy resin, such as bisphenol A diglycidyl ether, and combinations thereof.

Examples of arylaliphatic polyamines include, but are not limited to, m-xylylenediamine (mXDA), and p-xylylenediamine. Examples of cycloaliphatic polyamines include, but are not limited to, 1,3-bisaminocyclohexylamine (1,3-BAC), isophorone diamine (IPDA), and 4,4′-methylenebiscyclohexaneamine. Examples of aromatic polyamines include, but are not limited to, m-phenylenediamine, diaminodiphenylmethane (DDM), and diaminodiphenylsulfone (DDS). Examples of heterocyclic polyamines include, but are not limited to, N-aminoethylpiperazine (NAEP), 3,9-bis(3-aminopropyl) 2,4,8,10-tetraoxaspiro(5,5)undecane, and combinations thereof.

Examples of polyalkoxy polyamines include, but are not limited to, 4,7-dioxadecane-1,10-diamine; 1-propanamine; (2,1-ethanediyloxy)-bis-(diaminopropylated diethylene glycol) (ANCAMINE® 1922A); poly(oxy(methyl-1,2-ethanediyl)), alpha-(2-aminomethylethyl)omega-(2-aminomethylethoxy) (JEFFAMINE® D-230, D-400); triethyleneglycoldiamine; and oligomers (JEFFAMINE® XTJ-504, JEFFAMINE® XTJ-512); poly(oxy(methyl-1,2-ethanediyl)), alpha,alpha'-(oxydi-2,1-etha nediyl)bis(omega-(aminomethylethoxy)) (JEFFAMINE® XTJ-511); bis(3-aminopropyl)polytetrahydrofuran 350; bis(3-aminopropyl)polytetrahydrofuran 750; poly(oxy(methyl-1,2-ethanediyl)); α-hydro-ω-(2-aminomethylethoxy)ether with 2-ethyl-2-(hydroxymethyl)-1,3-propanediol (JEFFAMINE® T-403); diaminopropyl dipropylene glycol; and combinations thereof.

Examples of dicyandiamide derivatives include, but are not limited to, guanazole, phenyl guanazole, cyanoureas, and combinations thereof.

Examples of aminoamides include, but are not limited to, amides formed by reaction of the above aliphatic polyamines with a stoichiometric deficiency of anhydrides and carboxylic acids, as described in U.S. Pat. No. 4,269,742.

Examples of amidines include, but are not limited to, carboxamidines, sulfinamidines, phosphinamidines, and combinations thereof.

Examples of ketimines include compounds having the structure (R²)₂C═NR³, where each R² is an alkyl group and R³ is an alkyl group or hydrogen, and combinations thereof.

For one or more of the embodiments, the curing agent can include an anhydride. An anhydride is a compound having two acyl groups bonded to the same oxygen atom. The anhydride can be symmetric or mixed. Symmetric anhydrides have identical acyl groups. Mixed anhydrides have different acyl groups. The anhydride is selected from the group consisting of aromatic anhydrides, alicyclic anhydrides, aliphatic anhydride, polymeric anhydrides, and combinations thereof.

Examples of aromatic anhydrides include, but are not limited to, 3,3′,4,4′-benzophenonetetracarboxylic dianhydride, pyromellitic anhydride, and combinations thereof.

Examples of alicyclic anhydrides include, but are not limited to methyltetrahydrophthalic anhydride, tetrahydrophthalic anhydride, methyl nadic anhydride, hexahydrophthalic anhydride, methylhexahydrophthalic anhydride, and combinations thereof.

Examples of aliphatic anhydrides include, but are not limited to, propionic anhydride, acetic anhydride, and combinations thereof.

Example of a polymeric anhydrides include, but are not limited to, polymeric anhydrides produced from copolymerization of maleic anhydride such as poly(styrene-co-maleic anhydride) copolymer, and combinations thereof.

For one or more of the embodiments, the curing agent can include a carboxylic acid. Examples of carboxylic acids include oxoacids having the structure R⁴C(═O)OH, where R⁴ is an alkyl group or hydrogen, and combinations thereof.

For one or more of the embodiments, the curing agent can include a phenol. Examples of phenols include, but are not limited to, bisphenols, novolacs, and resoles that can be derived from phenol and/or a phenol derivative, and combinations thereof.

For one or more of the embodiments, the curing agent can include a thiol. Examples of thiols include compounds having the structure R⁵SH, where R⁵ is an alkyl group, and combinations thereof.

For one or more embodiments, the curable compositions can include a catalyst. Examples of the catalyst include, but are not limited to, 2-methyl imidazole, 2-phenyl imidazole, 2-ethyl-4-methyl imidazole, 1-benzyl-2-phenylimidazole, boric acid, triphenylphosphine, tetraphenylphosphonium-tetraphenylborate, and combinations thereof. The catalyst can be used in an amount of from 0.01 to 5 parts per hundred parts of the epoxy compound; for example the catalyst can be used in an amount of from 0.05 to 4.5 parts per hundred parts of the epoxy compound or 0.1 to 4 parts per hundred parts of the epoxy compound.

For one or more embodiments, the curable compositions can include an inhibitor. The inhibitor can inhibit the activity of the catalyst during formation of a prepreg, e.g. B-staging. The inhibitor can be a Lewis acid. Examples of the inhibitor include, but are not limited to, boric acid, halides, oxides, hydroxides and alkoxides of zinc, tin, titanium, cobalt, manganese, iron, silicon, boron, aluminum, and combinations thereof. Boric acid as used herein refers to boric acid or derivatives thereof, including metaboric acid and boric anhydride. The curable compositions can contain from 0.3 moles of inhibitor per mole of catalyst to 3 moles of inhibitor per mole of catalyst; for example the curable compositions can contain from 0.4 moles of inhibitor per mole of catalyst to 2.8 moles of inhibitor per mole of catalyst or 0.5 moles of inhibitor per mole of catalyst to 2.6 moles of inhibitor per mole of catalyst.

For one or more of the embodiments, the curable compositions can include a halogenated flame retardant additive, a non-halogenated flame retardant additive, and/or an inorganic flame retardant additive. Reactive flame retardants (those flame retardants that form covalent bonds with one or more of the components of the curable compositions) or inert, metal containing materials are preferred.

For one or more of the embodiments, the curable compositions can include a halogenated flame retardant additive. The halogenated flame retardant additive can be from 5 weight percent to 30 weight percent of the curable composition; for example the halogenated flame retardant additive can be from 7 weight percent to 25 weight percent or from 10 weight percent to 20 weight percent of the curable composition.

The halogenated flame retardant additive can include a halogenated epoxy compound, such as a brominated epoxy compound, a halogenated phenolic hardener, tetrabromobisphenol A (TBBA) and its derivatives, a brominated novolac and its polyglycidyl ether, TBBA epoxy oligomers, brominated polystryrene, tetrabromobisphenol-S, and combinations thereof. Some suitable commercially available products include, but are not limited to, D.E.R.™ 542 (the diglycidyl ether of TBBA), and brominated ‘advanced’ resins such as D.E.R.™ 560, D.E.R.™ 530, D.E.R.™ 592, which are available from The Dow Chemical Company. Advanced resins can be produced by reaction of a difunctional epoxy resin with a difunctional phenolic hardener.

For one or more of the embodiments, the curable compositions can include a non-halogenated flame retardant additive. The non-halogenated flame retardant additive can be from 5 weight percent to 75 weight percent of the curable composition; for example the non-halogenated flame retardant additive can be from 10 weight percent to 70 weight percent or from 15 weight percent to 65 weight percent of the curable composition.

The non-halogenated flame retardant additive can include a phosphorous compound. Examples of phosphorous compounds include, but are not limited to, phosphinates, phosphonates, phosphates, phosphazenes, metal salts of phosphorus acids, organic salts of phosphorus acids, and combinations thereof.

Examples of phosphinates include, but are not limited to, phosphinate salts, phosphinate esters, diphosphinic acids, dimethylphosphinic acid, ethylmethylphosphinic acid, diethylphosphinic acid, the salts of these acids, such as the aluminum salts and the zinc salts, and combinations thereof. Specific examples of the salts include, but are not limited to, EXOLIT® OP 910, EXOLIT® OP 930, and EXOLIT® OP 950 available from Clariant. Additional phosphinates include, but are not limited to, derivatives of ‘DOP’ (9,10-dihydro-9-oxa-10-phosphaphenanthren-10-oxide) as described in U.S. Patent Application Publication No. 20070221890, U.S. Pat. No. 6,645,631, U.S. Patent Application Publication No. 20060149023, and by Wang in Polymer, Vol 39, No. 23, 5819-5826.

Examples of phosphonates include, but are not limited to, derivatives of cyclic phosphonates such as 5,5-dimethyl-2-oxido-1,3,2-dioxaphosphorinane as described in U.S. Pat. No. 6,645,631, and combinations thereof.

Examples of phosphates include, but are not limited to, ammonium polyphosphate, such as EXOLIT® 700 available from Clariant, melamine polyphosphate, and combinations thereof.

Examples of phosphazenes include, but are not limited to, hydroxyphenoxyphosphazene, phenoxyphosphazene, methylphenoxyphosphazene, cresylphosphazene, xylenyloxyphosphazene, methoxyphosphazene, ethoxyphosphazene, propoxyphosphazene, and combinations thereof.

For one or more of the embodiments, the non-halogenated flame retardant additive can include an antimony or boron compound or salt. Examples of antimony compounds include, but are not limited to antimony oxides, such as Sb₂O₃ and Sb₃O₅. Examples of borates include, but are not limited to, zinc borate, zinc metaborate, barium metaborate, sodium borate, and combinations thereof.

For one or more of the embodiments, the curable compositions can include an inorganic flame retardant. Examples of inorganic flame retardants include, but are not limited to, magnesium oxide, magnesium chloride, talcum, alumina hydrate, zinc oxide, alumina trihydrate, alumina magnesium, calcium silicate, sodium silicate, zeolite, magnesium hydroxide, sodium carbonate, calcium carbonate, ammonium molybdate, iron oxide, copper oxide, zinc phosphate, zinc chloride, silica, clay, quartz, mica, sodium dihydrogen phosphate, and combinations thereof. The inorganic flame retardant can be from 5 weight percent to 75 weight percent of the curable composition; for example the non-halogenated flame retardant additive can be from 10 weight percent to 70 weight percent of the curable composition or from 15 weight percent to 65 weight percent of the curable composition.

The curable compositions can have a phosphorous content of from 0.1 weight percent to 10 weight percent of the curable composition; for example the curable compositions can have a phosphorous content of from 0.5 weight percent to 9 weight percent of the curable composition, from 1.0 weight percent to 8 weight percent of the curable composition, or from 3 weight percent to 10 weight percent of the curable composition.

The components of the curable compositions can be summed to give 100 weight percent of the curable compositions. The components of the curable compositions can be mixed, ground, and/or extruded by one or more processes. A suitable device or a combination of suitable devices may be employed for the mixing, grinding, and/or extruding. Parameters for the mixing, grinding, and/or extruding may vary from one application to another, as is known in the art. One example of mixing is melt-mixing. However, other types of mixing may be employed for particular applications.

The components of the curable compositions can be ground, e.g. milled, to an average particle size. For example, the components of the curable composition can be cryoground or ground by other grinding procedures known in the art. The components of the curable composition can be ground to an average particle size of 1 micrometers (μm) to 100 μm; for example the components of the curable composition can be ground to an average particle size of 3 μm to 75 μm or 5 μm to 50 μm. For one or more embodiments, the components of the curable composition have an average particle size of 1 μm to 10 μm.

The components of the curable compositions can be extruded. The extrusion process may be a reactive extrusion. The extrusion process can be carried out in conventional processing equipment such as a single screw extruder, or a twin screw extruder, or other processing equipment.

Embodiments of the present disclosure provide prepregs. The prepreg can be obtained by a process that includes impregnating a matrix component into a reinforcement component. The matrix component surrounds and/or supports the reinforcement component. The curable compositions as disclosed herein can be used for the matrix component. The matrix component and the reinforcement component of the prepreg provide a synergism. This synergism provides that the prepregs and/or products obtained by curing the prepregs have mechanical and/or physical properties that are unattainable with only the individual components.

The reinforcement component can be a fiber. Examples of fibers include, but are not limited to, glass, aramid, carbon, polyester, polyethylene, quartz, metal, ceramic, biomass, and combinations thereof. The fibers can be coated. An example of a fiber coating includes, but is not limited to, boron.

Examples of glass fibers include, but are not limited to, A-glass fibers, E-glass fibers, C-glass fibers, R-glass fibers, S-glass fibers, T-glass fibers, and combinations thereof. Aramids are organic polymers, examples of which include, but are not limited to, Kevlar®, Twaron®, and combinations thereof. Examples of carbon fibers include, but are not limited to, those fibers formed from polyacrylonitrile, pitch, rayon, cellulose, and combinations thereof. Examples of metal fibers include, but are not limited to, stainless steel, chromium, nickel, platinum, titanium, copper, aluminum, beryllium, tungsten, and combinations thereof. Examples of ceramic fibers include, but are not limited to, those fibers formed from aluminum oxide, silicon dioxide, zirconium dioxide, silicon nitride, silicon carbide, boron carbide, boron nitride, silicon boride, and combinations thereof. Examples of biomass fibers include, but are not limited to, those fibers formed from wood, non-wood, and combinations thereof.

The reinforcement component can be a fabric. The fabric can be formed from the fiber, as discussed herein. Examples of fabrics include, but are not limited to, stitched fabrics, woven fabrics, and combinations thereof. The fabric can be unidirectional, multiaxial, and combinations thereof. The reinforcement component can be a combination of the fiber and the fabric.

The prepreg is obtainable by impregnating the matrix component into the reinforcement component. Impregnating the matrix component into the reinforcement component may be accomplished by a variety of processes. One process for obtaining the prepreg is pressing. For example, the matrix component, i.e. the disclosed curable composition, may be spread to contact the reinforcement component. The matrix component may contact one or both of the major surfaces of the reinforcement component to form a layered article. The layered article may be placed into a press where it subjected to force for a predetermined time interval to obtain the prepreg. The press may have a temperature of 80 degrees Celsius (° C.) to 140° C.; for example the press may have a temperature of 90° C. to 130° C. or 100° C. to 120° C. During the pressing, the layered article is subjected to a pressure via the press. The pressure may have a value that is 20 kilopascals (kPa) to 700 kPa; for example the pressure may have a value that is 30 kPa to 500 kPa or 70 kPa to 400 kPa. The pressure can be applied for the predetermined time interval. The predetermined time interval may have a value that is 30 seconds (s) to 120 s; for example the predetermined time interval may have a value that is 40 s to 110 s or 50 s to 100 s. For other processes for obtaining the prepreg other press temperatures, pressure values, and/or predetermined time intervals are possible.

One or more of the prepregs may be more fully cured to obtain a product. The prepregs can be layered or/and formed into a shape before being more cured. For some applications, e.g. when an electrical laminate is being produced, layers of the prepreg can be alternated with layers of a conductive material. An example of the conductive material includes, but is not limited to, copper foil. The prepreg layers can then be exposed to conditions so that the matrix component becomes more fully cured. One example of a process for obtaining the more fully cured product is pressing. The prepreg may be placed into a press where it subjected to a curing force for a predetermined curing time interval to obtain the more fully cured product. The press may have a curing temperature of 80° C. to 250° C.; for example the press may have a curing temperature of 90° C. to 240° C. or 100° C. to 230° C. For one or more embodiments, the press has a curing temperature that is ramped from a lower curing temperature to a higher curing temperature over a ramp time interval.

During the pressing, the layered article can be subjected to a curing force via the press. The curing force may have a value that is 20 kPa to 350 kPa; for example, the curing force may have a value that is 30 kPa to 300 kPa or 70 kPa to 275 kPa. In addition to the ramp time interval, the curing force may be applied for a predetermined curing time interval. The predetermined curing time interval may have a value that is 5 s to 500 s; for example the predetermined curing time interval may have a value that is 25 s to 450 s or 45 s to 400 s. For other processes for obtaining the prepreg other curing temperatures, ramp time intervals, curing pressure values, and/or predetermined curing time intervals are possible. Additionally, the process may be repeated to further cure the prepreg and obtain the product.

For one or more embodiments, the product obtained by curing one or more prepregs can have a V-0 or V-1 flame classification according to UL-94 (Underwriters Laboratories) at 1.5 millimeters thickness. The UL-94 tests can measure the propensity of a material to extinguish or spread flames once it becomes ignited and can serve as a preliminary indication of a material's acceptability with respect to flammability for a particular application. The V-0 and V-1 flame classifications indicate that the material was tested in a vertical position and self-extinguished within a specified time, for each respective flame classification, after the ignition source was removed. The V-0 flame classification indicates that burning stops within 10 seconds after two applications, of ten seconds each, of a flame to a test bar and no flaming drips are observed. The V-1 flame classification indicates that burning stops within 60 seconds after two applications, of ten seconds each, of a flame to a test bar and no flaming drips are observed.

The product obtained by curing one or more prepregs can have a glass transition temperature (Tg) of at least 100° C. For example, the product obtained by curing one or more prepregs can have a glass transition temperature from 100° C. to 500° C. or 110° C. to 475° C.

The product obtained by curing one or more prepregs can have a thermal degradation temperature (Td) of at least 310° C. For example, the product can have a thermal degradation temperature of 310° C. to 500° C., or 320° C. to 475° C.

### EXAMPLES

In the Examples, various terms and designations for materials were used including, for example, the following:

Epoxy compound: D.E.N.™ 439, available from The Dow Chemical Company.

Epoxy compound: D.E.R.™ 6508, available from The Dow Chemical Company.

Curing agent: DURITE® 357-D, available from Hexion.

Curing agent: REZICURE® 3020, available from the SI Group.

Catalyst: boric acid, available from Sigma Aldrich Chemical Company.

Catalyst: 2-methyl imidazole, available from Sigma Aldrich Chemical Company.

Phosphono-methyl-glycine: glyphosate, available from Monsanto.

Non-halogenated flame retardant additive: EXOLIT® OP 950, available from Clariant International Ltd.

Inorganic flame retardant: silica (AST 600), available from Quarzwerke.

Reinforcement component: Glass cloth (Style 7628), available from JBS/Hexacel.

Release sheet, available from Duo Foil.

Melt Mixing

Melt-mixture 1 was prepared as follows. D.E.N.™ 439 (17.50 grams), D.E.R.™ 6508 (13.13 grams), and DURITE® 357-D (1.80 grams) were stirred at 140 to 150° C. for 60 minutes in a vessel to form melt-mixture 1. Melt-mixture 1 was poured onto aluminum foiled and cooled to 20° C. After cooling melt-mixture 1 was cracked into a number of pieces. Melt-mixtures 2-7 were prepared similarly to melt-mixture 1. The compositions of melt-mixtures 1-7 are shown in Table I. Melt-mixtures 2-7 were also cooled and cracked into a number of pieces.

TABLE I

| Melt-mixture | Epoxy compound | | Curing agent |
|---|---|---|---|
| # | D.E.N. ™ 439 | D.E.R. ™ 6508 | DURITE ® 357-D |
| Melt-mixture | 17.50 (g) | 13.13 (g) | 1.80 (g) |
| 1 | | | |
| Melt-mixture | 17.50 (g) | 13.13 (g) | 1.88 (g) |
| 2 | | | |
| Melt-mixture | 17.50 (g) | 13.13 (g) | 0.38 (g) |
| 3 | | | |
| Melt-mixture | 420.00 (g) | 315.00 (g) | 19.50 (g) |
| 4 | | | |
| Melt-mixture | 15.75 (g) | 11.82 (g) | 0.74 (g) |
| 5 | | | |
| Melt-mixture | 15.47 (g) | 10.05 (g) | 0.72 (g) |
| 6 | | | |
| Melt-mixture | 14.18 (g) | 10.64 (g) | 0.67 (g) |
| 7 | | | |

### Examples 1-7

### Curable Compositions

The pieces of melt-mixture 1, REZICURE® 3020 (4.75 grams), boric acid (0.13 grams), 2-methyl imidazole (0.058 grams), and glyphosate (5.13 grams) were ground to an average particle size of 1 to 10 micrometers in a PRISM Pilot grinder to form Example 1, a curable composition. Examples 2-7 were formed as Example 1, with the changes: melt-mixtures 2-7 replaced melt-mixture 1 for Examples 2-7, respectively; Examples 4-6 included a flame retardant additive; and Example 8 included an inorganic filler. The components of Examples 1-7 are shown in Table II.

TABLE II

| | | | | | Phosphono- | | | Flame | |
|---|---|---|---|---|---|---|---|---|---|
| | | | | | methyl- | Catalyst | | retardant | Inorganic |
| | Epoxy compound | | Curing Agent | | glycine | 2-methyl | | additive | filler |
| Example | D.E.N. ™ | D.E.R. ™ | DURITE ® | REZICURE ® | Glyphosate | imidazole | Boric | EXOLIT ® | Silica |
| # | 439 (g) | 6508 (g) | 357-D (g) | 3020 (g) | (g) | (g) | acid (g) | OP 950 (g) | (g) |
| 1 | 17.50 | 13.13 | 1.80 | 4.75 | 5.13 | 0.058 | 0.13 | — | — |
| 2 | 17.50 | 13.13 | 1.88 | 7.50 | 4.13 | 0.061 | 0.12 | — | — |
| 3 | 17.50 | 13.13 | 0.38 | 1.88 | 8.13 | 0.063 | 0.32 | — | — |
| 4 | 420.00 | 315.00 | 19.50 | 105.00 | 150.00 | 1.260 | 3.15 | — | — |
| 5 | 15.75 | 11.82 | 0.74 | 3.94 | 5.63 | 0.150 | 0.12 | 4.21 | — |
| 6 | 15.47 | 10.05 | 0.72 | 3.87 | 5.53 | 0.130 | 0.12 | 6.58 | — |
| 7 | 14.18 | 10.64 | 0.67 | 3.55 | 5.07 | 0.140 | 0.11 | 3.78 | 4.10 |

Table III shows the phosphorous content of each of Examples 1-7 as a weight percentage of the respective curable composition.

TABLE III

| | Phosphorous content (weight |
|---|---|
| Example # | percent of the curable composition) |
| 1 | 2.25 |
| 2 | 2.70 |
| 3 | 3.60 |
| 4 | 2.70 |
| 5 | 4.40 |
| 6 | 5.40 |
| 7 | 4.00 |

Extrusion Process

A 24 millimeter PRISM twin screw extruder set a 20 rotations per minute and having a first zone temperature of 15° C., a second zone temperature of 50° C., and a third zone temperature of 75° C. was primed by adding D.E.R.™ 6508 (200 grams) to the extruder. Example 4 was fed to the primed extruder to provide extrusion product 1. Extrusion product 1 was ground by mortar and pestle and passed through a 30 mesh sieve to provide extrusion product powder 1. Extrusion product powders 2-3 were prepared as extrusion product powder 1, with the changes that curable compositions prepared as Examples 5-6 replaced Example 4, respectively.

### Examples 8, 9, 10, 12, 13, and 16

### Prepregs

Prepregs were obtained by impregnating a matrix component into a reinforcement component as follows. A layered article was prepared as follows. Two TYVEK® spacers were placed on a first metal sheet. A first release sheet was placed on the TYVEK® spacers. A 30.48 centimeter by 30.48 centimeter piece of the glass cloth was placed on the first release sheet. Five and one half (5.5) grams of Example 1 was placed on the glass cloth and spread into a circular shape. A second release sheet was placed on the glass cloth and Example 1. Two additional TYVEK® spacers were placed on the second release sheet. A second metal sheet was placed on the two additional TYVEK® spacers to form the layered article. The layered article was placed in a 115° C. Tetrahedron Press Model 1401. The press was closed at 5,000 pounds for 100 seconds. The release sheets were removed from the pressed layered article to provide Example 8, a prepreg. Examples 9, 10, 12, 13, and 16, prepregs, were prepared as Example 8, with the changes that Examples 2, 3, 5, 6, and 7 replaced Example 1 for Examples 9, 10, 12, 13, and 16, respectively.

### Examples 11, 14, and 15

### Prepregs

Prepregs were obtained by impregnating a matrix component into a reinforcement component as follows. A layered article was prepared as follows. Two TYVEK® spacers were placed on a first metal sheet. A first release sheet was placed on the TYVEK® spacers. Seventeen and one half (17.5) grams of extrusion product powder 1 was placed in the first release sheet and spread into a square shape. A 30.48 centimeter by 35.56 centimeter piece of the glass cloth was placed on extrusion product powder 1 and the first release sheet. An additional 17.5 grams of extrusion product powder 1 was placed on the glass cloth and spread into a square shape. A second release sheet was placed on the glass cloth and the additional extrusion product powder 1. Two additional TYVEK® spacers were placed on the second release sheet. A second metal sheet was placed on the two additional TYVEK® spacers to form the layered article. The layered article was placed in a 115° C. Tetrahedron Press Model 1401. The press was closed at 5,000 pounds for 100 seconds. The release sheets were removed from the pressed layered article to provide Example 11, a prepreg. Examples 14 and 15, prepregs, were prepared as Example 11, with the changes that extrusion product powders 2 and 3 replaced extrusion product powder 1 for Examples 14 and 15, respectively.

### Examples 16-24

### Products Obtained by Curing the Prepregs of Examples 8-16

Prepregs were cured using the Tetrahedron Press Model 1401. Example 8 was consecutively heated from about 37° C. to 140° C. at 10.8° C. per minute and held for 10 seconds while under a pressure of 8 psi; heated from 140° C. to 196° C. at 10.8° C. per minute and held for 90 minutes while under a pressure of 32 psi; and cooled from 196° C. to 38° C. at 27° C. per minute and held for 30 seconds while under a pressure of 32 psi to provide Example 16, a product obtained by curing Example 8.

Example 9 was consecutively heated from about 37° C. to 134° C. at 14.4° C. per minute and held for 10 seconds while under a pressure of 7 psi; heated from 134° C. to 190° C. at 14.4° C. per minute and held for 90 minutes while under a pressure of 20 psi; and cooled from 190° C. to 38° C. at 27° C. per minute and held for 30 seconds while under a pressure of 20 psi to provide Example 17, a product obtained by curing Example 9.

Example 10 was consecutively heated from about 37° C. to 140° C. at 10.8° C. per minute and held for 10 seconds while under a pressure of 10 psi; heated from 140° C. to 196° C. at 10.8° C. per minute and held for 90 minutes while under a pressure of 30 psi; and cooled from 196° C. to 38° C. at 27° C. per minute and held for 30 seconds while under a pressure of 30 psi to provide Example 18, a product obtained by curing Example 10.

Example 11 was consecutively heated from about 37° C. to 140° C. at 14.4° C. per minute and held for 10 seconds while under a pressure of 8 psi; heated from 140° C. to 190° C. at 14.4° C. per minute and held for 90 minutes while under a pressure of 60 psi; and cooled from 190° C. to 38° C. at 27° C. per minute and held for 60 seconds while under a pressure of 60 psi to provide Example 19, a product obtained by curing Example 11.

Example 12 was consecutively heated from about 37° C. to 134° C. at 14.4° C. per minute and held for 10 seconds while under a pressure of 7 psi; heated from 134° C. to 196° C. at 14.4° C. per minute and held for 90 minutes while under a pressure of 20 psi; and cooled from 196° C. to 38° C. at 27° C. per minute and held for 30 seconds while under a pressure of 20 psi to provide Example 20, a product obtained by curing Example 12.

Example 13 was consecutively heated from about 37° C. to 134° C. at 12.6° C. per minute and held for 10 seconds while under a pressure of 10 psi; heated from 134° C. to 196° C. at 12.6° C. per minute and held for 90 minutes while under a pressure of 30 psi; and cooled from 196° C. to 38° C. at 27° C. per minute and held for 30 seconds while under a pressure of 30 psi to provide Example 21, a product obtained by curing Example 13.

Example 14 was consecutively heated from about 37° C. to 146° C. at 16.2° C. per minute and held for 10 seconds while under a pressure of 12 psi; heated from 143° C. to 198° C. at 14.4° C. per minute and held for 90 minutes while under a pressure of 90 psi; and cooled from 198° C. to 38° C. at 27° C. per minute and held for 60 seconds while under a pressure of 90 psi to provide Example 18, a product obtained by curing Example 12.

Example 15 was consecutively heated from about 37° C. to 146° C. at 14.4° C. per minute and held for 10 seconds while under a pressure of 10 psi; heated from 146° C. to 190° C. at 14.4° C. per minute and held for 90 minutes while under a pressure of 85 psi; and cooled from 190° C. to 38° C. at 36° C. per minute and held for 60 seconds while under a pressure of 85 psi to provide Example 23, a product obtained by curing Example 15.

Example 16 was consecutively heated from about 37° C. to 134° C. at 14.4° C. per minute and held for 10 seconds while under a pressure of 7 psi; heated from 134° C. to 196° C. at 14.4° C. per minute and held for 90 minutes while under a pressure of 20 psi; and cooled from 196° C. to 38° C. at 27° C. per minute and held for 30 seconds while under a pressure of 20 psi to provide Example 24, a product obtained by curing Example 16.

Example 16-24 flame classifications were determined using the 94V Vertical Burning Test, wherein a ½ inch by 5 inch bar is held at one end in the vertical position and a burner flame is applied to the free end of the bar for two 10 second intervals separated by the time it takes for flaming combustion to cease after the first application. Two sets of 5 bars were tested to determine a duration of flaming combustion after the first burner flame application (extinguish time 1), a duration of flaming combustion after second burner flame application (extinguish time 2), and the corresponding UL-94 flame classification. The results of this testing are shown in Table IV.

TABLE IV

| | | Extinguish | Extinguish | Flame |
|---|---|---|---|---|
| | | Time 1 | Time 2 | classification |
| Example # | Bar # | (seconds) | (seconds) | (UL-94) |
| Example 16 | Bar 1 | 43 | 8 | V-1 |
| | Bar 2 | 42 | 10 | |
| | Bar 3 | 48 | 9 | |
| | Bar 4 | 42 | 8 | |
| | Bar 5 | 35 | 5 | |
| Example 17 | Bar 1 | 49 | 4 | V-1 |
| | Bar 2 | 42 | 10 | |
| | Bar 3 | 48 | 5 | |
| | Bar 4 | 38 | 10 | |
| | Bar 5 | 33 | 10 | |
| Example 18 | Bar 1 | 48 | No ignition | No |
| | Bar 2 | 52 | No ignition | classification |
| | Bar 3 | 58 | No ignition | |
| | Bar 4 | 63 | No ignition | |
| | Bar 5 | 55 | No ignition | |
| Example 19 | Bar 1 | 42 | 4 | V-1 |
| | Bar 2 | 48 | 5 | |
| | Bar 3 | 41 | 4 | |
| | Bar 4 | 48 | 5 | |
| | Bar 5 | 41 | 5 | |
| Example 20 | Bar 1 | 1.5 | 13.1 | V-1 |
| | Bar 2 | 2.0 | 17.3 | |
| | Bar 3 | 9.6 | 2.9 | |
| | Bar 4 | 3.5 | 0.6 | |
| | Bar 5 | 0.7 | 28.9 | |
| Example 21 | Bar 1 | 2.2 | 4.2 | V-1 |
| | Bar 2 | 3.5 | 10.9 | |
| | Bar 3 | 8.5 | 5.8 | |
| | Bar 4 | 4.5 | 4.5 | |
| | Bar 5 | 1.2 | 10.1 | |
| Example 22 | Bar 1 | 1.0 | 13.8 | V-1 |
| | Bar 2 | 11.0 | 2.0 | |
| | Bar 3 | 6.5 | 2.9 | |
| | Bar 4 | 14.1 | 6.4 | |
| | Bar 5 | 7.4 | 4.2 | |
| Example 23 | Bar 1 | 10.0 | 6.4 | V-1 |
| | Bar 2 | 4.6 | 2.5 | |
| | Bar 3 | 4.3 | 2.0 | |
| | Bar 4 | 7.1 | 7.4 | |
| | Bar 5 | 4.3 | 3.7 | |
| Example 24 | Bar 1 | 5 | 2 | V-0 |
| | Bar 2 | 4 | 3 | |
| | Bar 3 | 9 | 4 | |
| | Bar 4 | 8 | 3 | |
| | Bar 5 | 4 | 4 | |

The data in Table IV shows that each of Examples 16-23 has a V-1 flame classification. The data in Table IV also shows that Example 24 has a V-0 flame classification.

Example 16-24 glass transition temperatures were determined using a Q200 Differential Scanning calorimeter from TA Instruments. The temperature of each sample was increased 10° C. per minute from 30° C. to 220° C. Glass transition temperature 1 is reported as the temperature at which the mid-point of the first-order transition is observed on the first temperature ramp. The temperature was maintained constant at 220° C. for 15 minute and then allowed to equilibrate at 30° C. Again, the temperature of the sample was increased 10° C. per minute from 30° C. to 220° C. Glass transition temperature 2 is reported as the mid-point temperature of the first-order transition. The temperature was maintained constant at 220° C. for 15 minute and then allowed to equilibrate at 30° C. The temperature of the sample was increased 20° C. per minute from 30° C. to 220° C. Glass transition temperature 3 is reported as the mid-point temperature of the first-order transition. Example 16-24 thermal degradation temperatures were determined by using a thermogravimetric analyzer (TGA) on a TA instruments Q50 analyzer. For analysis, the software program Universal Analysis V3.3B data was used. The method used for analysis was a ramp rate of 10° C./min to 600° C. in air. The 5 weight percent decomposition temperature was determined. The glass transition temperatures and thermal degradation temperatures are shown in Table V.

TABLE V

| | Glass | Glass | Glass | Thermal |
|---|---|---|---|---|
| | transition | transition | transition | degradation |
| | temperature 1 | temperature 2 | temperature 3 | temperature |
| Example # | (° C.) | (° C.) | (° C.) | (° C.) |
| Example 16 | 148.5 | 153.2 | 155.6 | 370.1 |
| Example 17 | 148.8 | 150.0 | 151.3 | 363.0 |
| Example 18 | 141.7 | 140.2 | 145.6 | 355.6 |
| Example 19 | 147.3 | 149.6 | 151.6 | 357.5 |
| Example 20 | 155.0 | 161.5 | 165.0 | 379.3 |
| Example 21 | 153.5 | 155.3 | 159.9 | 372.4 |
| Example 22 | 155.0 | 156.9 | 161.5 | 376.5 |
| Example 23 | 152.4 | 155.3 | 159.9 | 362.4 |
| Example 24 | 141.5 | 143.7 | 145.6 | 369.7 |

The data in Table V shows that each of Examples 16-24 has a glass transition temperature greater than 140° C. The data in Table V also shows that each of Examples 16-24 has a thermal degradation temperature greater than 355° C.

1. A curable composition comprising:
an epoxy compound selected from the group consisting of aromatic epoxy compounds, alicyclic epoxy compounds, aliphatic epoxy compounds, and combinations thereof;
a curing agent selected from the group consisting of novolacs, amines, anhydrides, carboxylic acids, phenols, thiols, and combinations thereof; and
a phosphono-methyl-glycine.

2. The curable composition of claim 1, where the phosphono-methyl-glycine is glyphosate.

3. The curable composition of claim 1, where the epoxy compound is 10 weight percent to 90 weight percent, the curing agent is 1 weight percent to 50 weight percent, and the phosphono-methyl-glycine is 0.5 weight percent to 50 weight percent of the curable composition.

4. A prepreg obtainable by impregnating a matrix component into a reinforcement component, wherein the matrix component comprises:
an epoxy compound;
a curing agent; and
a phosphono-methyl-glycine, wherein the matrix component of the prepreg has a phosphorus content of 0.1 weight percent to 10 weight percent.

5. The prepreg of claim 4, wherein the phosphono-methyl-glycine is glyphosate.

6. The prepreg of claim 4, wherein the epoxy compound is selected from the group consisting of aromatic epoxy compounds, alicyclic epoxy compounds, aliphatic epoxy compounds, and combinations thereof.

7. The prepreg of claim 4, wherein the curing agent is selected from the group consisting of novolacs, amines, anhydrides, carboxylic acids, phenols, thiols, and combinations thereof.

8. The prepreg of claim 4, wherein the matrix component further comprises a non-halogenated flame retardant additive and the matrix component of the prepreg has a phosphorus content of 3 weight percent to 10 weight percent.

9. The prepreg of claim 8, wherein the matrix component further comprises an inorganic flame retardant.

10. The prepreg of claim 9, wherein the epoxy compound is 10 weight percent to 90 weight percent, the curing agent is I weight percent to 50 weight percent, the phosphono-methyl-glycine is 0.5 weight percent to 50 weight percent, the non-halogenated flame retardant additive is 5 weight percent to 75 weight percent, and the inorganic flame retardant is 5 weight percent to 75 weight percent of the matrix component.

11. The prepreg of claim 10, wherein the matrix component further comprises a halogenated flame retardant additive and the halogenated flame retardant additive is 5 weight percent to 30 weight percent of the matrix component.

12. A product obtained by curing the prepreg of claim 4, wherein the product has a glass transition temperature of at least 100 degrees Celsius, a thermal degradation temperature of at least 310 degrees Celsius, and a V-0 or V-1 flame classification according to UL-94 at 1.5 millimeters thickness.
